(19) United States
(12) Patent Application Publication
(10) Pub. No.: US 2003/0011674 A1
(43) Pub. Date: Jan. 16, 2003

(54) Method and system for adjusting the image acquisition system of a microscope

(75) Inventor: Frank Olschewski, Heidelberg (DE)

Correspondence Address: SIMPSON & SIMPSON, PLLC, 5555 MAIN STREET, WILLIAMSVILLE, NY, 14221-5406, US

(73) Assignee: Leica Microsystems Heidelberg GmbH, Mannheim (DE)

(21) Appl. No.: 10/194,716

(22) Filed: Jul. 12, 2002

(30) Foreign Application Priority Data
Jul. 14, 2001 (DE) 101 34 328.0

(51) Int. Cl. H04N 7/18

(52) U.S. Cl. 348/80

(57) ABSTRACT

The system for adjusting the image acquisition system of a microscope (2) comprises a microscope (2) having an image data acquisition element (4), a memory element (10) being associated with the image data acquisition element (4). The image data acquisition element (4) is connected to a computer (14), and the transfer of image data from the memory element (10) and to the computer (14) is accomplished via a coder (20).

### CROSS REFERENCE TO RELATED APPLICATIONS

This application claims priority of the German patent application 101 34 328.0 which is incorporated by reference herein.

### FIELD OF THE INVENTION

The invention concerns a method for adjusting the image acquisition system of a microscope. The invention further concerns a system for adjusting the image acquisition of a microscope.

### BACKGROUND OF THE INVENTION

The coupling of an optical microscope to an image sensor and to a computer system is existing art. This applies to the coupling of microscopes to CCD camera systems, video camera systems, and scanning microscopes (confocal, multi-photon, 4-pi). What is critical in terms of the content of the invention is that in all such systems, the image sensor and computer system are coupled via a communication medium. Both the image sensor and the communication medium have memories, and transfer of the data between the components represents an information-technology problem. All information-technology concepts for the solution of such information-transfer problems, in particular the coding and compression of data that are to be transferred as well as the decoupling of components via buffer memories and schedule algorithms that operate at different rates or asynchronously, are part of the conventional knowledge of one skilled in this art.

If microscopes are considered from this information-technology standpoint, the literature is found to contain statements of the general attributes of information-transfer systems within and between the components of the microscope system. If the technical processes are linked to a human user, the transfer time of the technical system yields a variable that is highly relevant for the user, namely the latency time. The latency time is the minimum time required for an action performed by the user to show an effect. This variable, widely used in control engineering, can on occasion cause operator errors and minor experimental disasters in microscopy, which are prevented with this invention.

Dörner (D. Dörner, Die Logik des Misslingens—Strategisches Denken in komplexen Situationen [The logic of failure—strategic thinking in complex situations], Rowohlt, Reinbeck 1989) describes in his experimental psychology treatise the destabilizing influence of latency times (called “dead times”) on controlled systems and the inherent human inability to cope with them. A mental dead-time compensation would be necessary, but human capabilities in this area are generally inadequate. Similar considerations also apply in technical systems.

Tietze and Schenk (Tietze, Schenk, Halbleiterschaltungstechnik [Semiconductor circuit engineering] Springer, Berlin) disclose electronic components for decoupling asynchronous components that are written to at different rates. These include, for example, the FIFO memory components mentioned below.

Bovic (Bovic, Image and Video Processing, Academic Press, 2000) discloses the existing art for compressing and coding image data, including recent transform-based compression methods based, for example, on wavelet transformation. Standard compression methods for coding any kind of data stream may be found in practically any textbook on information technology or electrical engineering.

This invention is also, with no limitation of generality, described concretely using the example of a confocal scanning microscope, it being sufficiently clear to one skilled in the art that a concrete embodiment is possible with the other systems as well.

### SUMMARY OF THE INVENTION

The underlying object of the invention is a method for adjusting the image acquisition system of a microscope that reacts flexibly to the work of the microscope user and supplies the requisite image quality or image information, is adaptable, and meets predefined time criteria.

This object is achieved by way of a method that comprises the following steps:

providing an electronic control system associated with an image data acquisition element

providing a computer for controlling the image acquisition system of the microscope and for processing the image data from the microscope,

transferring image data from the image data acquisition element to a memory element;

transferring control parameters to a coder;

coding the image data from the memory element before transferring the image data to the computer; and

processing the image data by the computer.

A further object of the invention is to implement a system for adjusting the image acquisition system of a microscope that reacts flexibly to the work of the microscope user, supplies the requisite image quality or image information, and is adaptable, in order to achieve fast and efficient transfer of data from the microscope to a computer and thus to meet predefined time criteria.

The object is achieved by way of a system comprising:

a microscope,

an image data acquisition element and a memory element associated with the microscope,

a computer to which the image data acquisition element is connected, and

a coder via which the transfer of image data from the memory element and to the computer is accomplished.

The invention implements a method for adjusting the image acquisition system of a microscope. An image data acquisition element with associated electronic control system, and a computer for controlling the image acquisition system of the microscope, are provided for the purpose. The image acquisition element possesses inherent memory properties (e.g. CCD camera) or is coupled to a memory element for buffering of acquired data (e.g. PMT, ADC, memory). The computer moreover serves to process the image data from the microscope or from the memory element. A coder couples the memory element and the computer. The person skilled in the art is sufficiently aware that coupling of the individual components can be accomplished via a multitude of interfaces (including proprietary electronics, bus systems, interfaces such as RS232, SCSI, FireWire, USB, USB2, future interfaces with the goal of data transfer). The method itself comprises the following steps:

transfer of the image data from the image data acquisition element to a memory element;

transfer of control parameters to a coder;

coding of the image data from the memory element before transfer of the image data to the computer; and

processing of the image data by the computer.

The central idea is to modify the behavior of the coder during operation as a function of microscope control parameters. The coder control parameters can be derived implicitly or explicitly from actions of the user, who sets or adjusts various qualities, such as control parameters of the microscope or image quality features, while working interactively. Possible qualities of this kind are the brightness of the image, the spectral excitation, the tuning of an SP module (cf. in this connection German Patent DE 43 30 347), the densitometric and spectral properties of the illumination, the properties of the detector being used, or the sharpness of the image. As a function of these qualities, the coder will adapt the coding of the image data received by the image data acquisition element in order to achieve a transfer that corresponds to the requirements. In other words, the coder is adaptive, and switches between different codings as a function of the control parameters.

The memory element stores the acquired data in a native format that manages either pixels, lines (1D), frames (2D), or volumes (3D) as the smallest accessible unit, and as a rule manages more than one of said units. The memory element used is usually constituted as a list, and is filled and emptied in accordance with the FIFO (first in, first out) principle. This is usual for the decoupling of components that operate only at different speeds or asynchronously. The coder is equipped with a set of different coding methods of different quality.

In an advantageous embodiment, the control signal for the coder is generated by the PC or by a special software component (oracle). In a less advantageous embodiment, the control signals are generated by other external sources (e.g. handheld device). Note that a software component (oracle) can generate the control signals directly upon instruction by the user, but also, by intelligent use of the program logic that is necessarily present, intelligently evaluate the user's intentions (which he or she as a rule has necessarily conveyed with his or her most recent interactions) and generate corresponding control signals. One example is, for example, setting the section plane of a 3D scanning confocal microscope, which is initiated via a slider, rotary knob, or spin control in the PC or in an adjacent positioning apparatus and which informs the oracle that a rapid reaction time for adjustment operations is desired, whereupon the oracle turns down the image quality until a real-time depiction is possible. An action of this kind is then automatically switched off again by the oracle upon termination of the user interaction. Since the operation is invisible to the user, the term “oracle” was selected for the software component.

The system for adjusting the image acquisition system of a microscope comprises an image data acquisition element and a memory element, the image data acquisition element being connected to a computer. It is particularly advantageous that the transfer of image data from the memory element to the computer is accomplished via a coder. Control parameters can be transferred via the computer to the coder on the basis of user inputs. As already mentioned above, a software program (oracle) that transmits control parameters for selection of the coding method to the coder as a function of user inputs is provided on the computer. The image acquisition element possesses an electronic control system; the coder, which is implemented as an electronic component, is provided between the computer and the electronic control system of the image acquisition element.

### BRIEF DESCRIPTION OF THE DRAWINGS

The subject matter of the invention is depicted schematically in the drawings and will be described below with reference to the Figures, in which:

FIG. 1 schematically depicts a system according to the existing art;

FIG. 2 schematically depicts the reconfiguration according to the present invention of the existing art of FIG. 1;

FIG. 3 schematically depicts a binning compression method; and

FIG. 4 schematically depicts a wavelet transformation method.

### DETAILED DESCRIPTION OF THE INVENTION

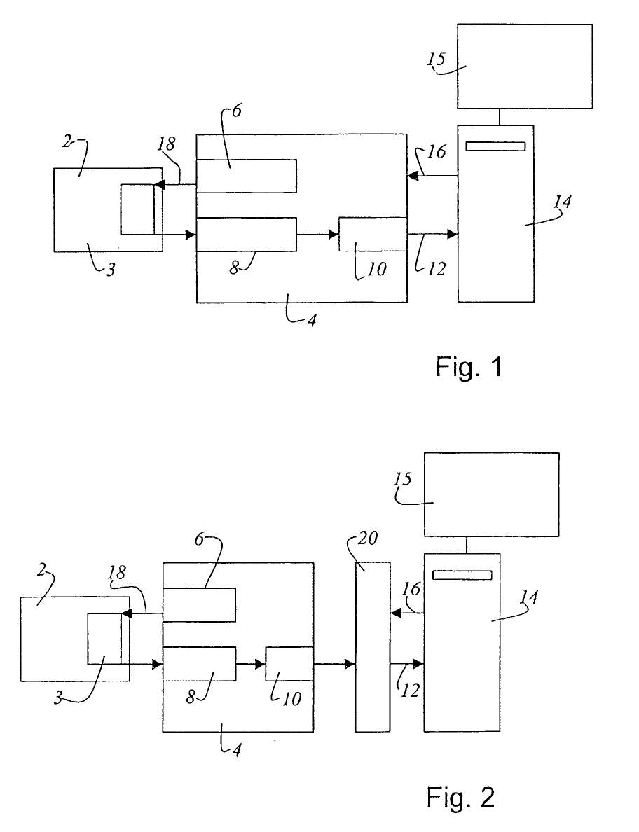

FIG. 1 describes a system according to the existing art that serves substantially for electronic image acquisition of the image data supplied by a microscope 2. The individual constituents or components of a microscope 2 need not be discussed further in this context, since they are sufficiently known. Microscope 2 is equipped with an arrangement 3 for image generation. Associated with microscope 2 is an image data acquisition element 4 that is made up of an electronic control system 6, an image sensor 8, and a memory element 10. From memory element 10, the data travel via a first signal line 12 to a computer 14. Adjustment data, measurement parameters, and user inputs are transmitted from computer 14 to image data acquisition element 4 via a second signal line 16. Electronic control system 6 acts via a third signal line 18 on specific components of microscope 2. For different microscopic examination tasks, it is desirable to maximize the acquisition rate of microscope 2 or of the microscope system in such a way that the essential time constants of the process are adhered to. Such applications occur, for example, in biophysics or in physiological examinations, in which the processes within the specimen, rather than the images of the microscope itself, are of interest. It must be ensured that the acquisition rate of microscope 2 is at least twice as great as the fastest frequency in the observed process (Nyquist criterion). For this reason, the image sensor is operated at a rate typical of the process. In the system described, image sensor 8 can be operated at a rate T₁ that most often is greater than the rate T₂ at which downstream data visualization devices (terminals, displays, video systems, or computer 14) can accept the data. The terms “producer process” and “consumer process” are used in this context. For this reason, it is necessary in such cases for memory element 10 to be positioned between the image sensor and the computer in order to effect buffering between the different rates T₁ and T₂ and in order to achieve an equalization of the rates for a certain period of time. Memory element 10 is positioned as close as possible to image sensor 8 in order thereby to achieve a decoupling of the different processing processes in image sensor 8 and in computer 14. In the case depicted in FIG. 1, electronic control system 6 and image sensor 8 fill up memory element 10 quickly, while the slow device (in this case computer 14) reads out memory element 10 slowly. Memory element is a FIFO (first in, first out) memory. Because of the different rates T₁ and T₂, a wait queue forms in memory 10, with a length W that is calculated as follows:

W=(T₁−T₂)*t

where t is the time since the beginning of data acquisition. Before it can be present in computer 14, a data element must pass through the system depicted in FIG. 1. Given the different rates, the goals of a high acquisition rate and a high processing rate are irreconcilable. When all the components are operating at maximum rate, a time delay occurs between events of the process and additional processing in the subsequent components. This time delay increases with the operating time. This is particularly obtrusive when the user is performing adjustment operations that are then visible only after a delay. In addition, electronic control system 6 of the existing art depicted in FIG. 1 handles data acquisition, and the control of microscope 2, on a central basis.

The embodiment according to the invention is depicted in FIG. 2. Elements that are identical to the elements of FIG. 1 are labeled with the same reference characters. Memory 10 is supplemented with a coder 20, and computer 14 controls data transfer from microscope 2 to computer 14. This feature allows maximum system performance. By way of computer 14, optionally also in combination with data visualization device 15, user inputs are made or suggested and are converted into corresponding control parameters and transferred to coder 20. Appropriate sliders or controllers, for example, with which specific inputs can be made for microscope 2, can be provided on data visualization device 15. A separate box with controllers can also be provided, thus offering a further adjustment capability for the user. Coder 20 then selects a suitable data transfer rate for the current adjustment problem on microscope 2. A number of different coding mechanisms can be selected for a variety of microscopy problems.

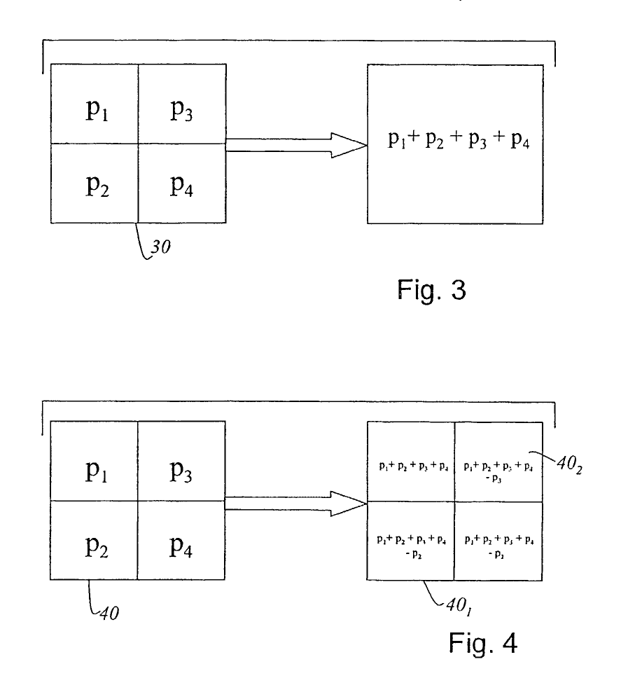

A partially suitable coding mechanism that is used, however, only for specific (and not all) objects of this invention is provided by CCD binning, and is illustrated in FIG. 3 with reference to a four-pixel (p₁, p₂, p₃, and p₄) image 30. The purpose of CCD binning is to increase the signal-to-noise ratio by combining adjacent pixels (p₁, p₂, p₃, and p₄) of the CCD chip. As a side effect, the image data set becomes smaller; this can be regarded as a lossy compression method. Coders of this kind can be used in the context of simple adjustment processes such as section plane adjustment and brightness modifications in confocal microscopy. It should also be noted that the image filtration implicitly occurring in this context is not optimal.

A remedy is provided by so-called multiscale approaches. A signal can be broken down into different scales by performing a repeated lowpass filtration. This task can be performed by filtration with a Gaussian core of different increasing variance, followed by downsampling. Coders of this kind can be used in the context of simple adjustment processes such as section plane adjustment and brightness changes in confocal microscopy.

Another interesting alternative, similar to the above method, is iterative filtration with Gaussian filters followed by downsampling. Coders of this kind can be used in the context of simple adjustment processes such as section plane adjustment and brightness changes in confocal microscopy.

A further variant is based on wavelet transformation, which is depicted in FIG. 4 using the example of a Haar wavelet. Like a Fourier transform, a wavelet transformation is an information-conserving transformation. The data set is projected onto a set of basic functions. In contrast to Fourier-based techniques, the basic functions represent a compromise between frequency localization and positional localization, and are not smeared over the entire time axis. In implementation, a wavelet transformation, represents a cascade of digital filters. A highpass filter H and lowpass filter T conjugated with one another are present, however, and not just lowpass filters, so that the information is retained in sum and is redistributed. The essential property of the filter design is that after the data transformation, every second data value can be omitted. A data packet 40 thus yields a first and a second data packet 40₁ and 40₂ which are half as big. The first data packet 40₁ represents a coarse image, and the second data packet 40₂ is the set of details required in order to reconstruct the original image from the coarse image. This can be illustrated as a branching point that separates details from coarse structures. If the filter coefficients are suitably selected, the lowpass branch then receives information about regions, and the highpass branch receives information about point sources and noise. Continuing this model recursively yields a tree of branching points and a hierarchy of details (the technical term is “scales”) and a coarse structure. The result is to break down the data packet into a vector (dⁿ, 40₁, 40₂, . . . 40ₙ), such that dⁿ is a highly coarsened data element and 40₁ . . . 40ₙ is the details at various scales. This model can be transferred to images by applying the model first by rows and then by columns. It can be correspondingly generalized to volume. dⁿ thus contains region data, 40₂ . . . 40ₙ contains further region details, and 40₁ contains point sources and most of the noise. Noncontinuous image elements such as edges would leave traces over all coefficients. If the filters were designed in accordance with multiscale analysis, the result would be a breakdown of the image into detail octaves. The filters used in this context are degrees of freedom of the implementation, and are coupled only to the multiscale analysis conditions. If the FIFO memory is followed by a wavelet transformation constituting the coder, if a selection of wavelet coefficients is performed by the PC, and if the transfer is reduced to that selection and decompressed in the PC by inverse transformation, then (assuming intelligent control) the desired information is retained. The data to be transferred are, so to speak, selected and shrunk in context-dependent fashion. An additional coding downstream on the basis of information-technology criteria (Huffman coding, perceptive requantization, zero trees, etc.) is of course also possible. Reversion to the coarse image is possible, for example, during any adjustment operation by the user (Z adjustment, gain, offset). A second-order wavelet transformation and reduction to the lowpass image thus yields a speedup equal to 2⁴=16. The coarse image is entirely adequate during most of these adjustment operations (image brightness, spectral tuning). During an autofocus operation, the location of maximum detail information is usually what is desired. The coarse image is relatively uninteresting and the finest detail image contains almost only noise; the middle octaves offer the most information. A fourth-order wavelet transformation and concentration on the middle octaves yields a speedup by a factor of 2.66.

The invention has been described with reference to a particular embodiment. It is nevertheless self-evident that changes and modifications can be made without thereby leaving the range of protection of the claims below.

What is claimed is:

1. A method for adjusting the image acquisition system of a microscope comprises the following steps:
providing an electronic control system associated with an image data acquisition element
providing a computer for controlling the image acquisition system of the microscope and for processing the image data from the microscope,
transferring image data from the image data acquisition element to a memory element;
transferring control parameters to a coder;
coding the image data from the memory element before transferring the image data to the computer; and
processing the image data by the computer.

2. The method as defined in claim 1, wherein the memory element is configured as a FIFO memory or ring buffer.

3. The method as defined in claim 1, wherein the coder switches between different codings as a function of the control parameters.

4. The method as defined in claim 1, wherein a software program is provided on the computer and transmits to the coder, as a function of user inputs, control parameters for selection of the coding method, the control parameters comprising the brightness, the spectral excitation, the tuning of an SP module, the illumination, the detector, or the sharpness.

5. The method as defined in claim 3, wherein the coder is equipped with a set of different coding methods of different quality and different scale resolution.

6. A system for adjusting the image acquisition system of a microscope, the system comprising:
a microscope,
an image data acquisition element and a memory element associated with the microscope,
a computer to which the image data acquisition element is connected, and
a coder via which the transfer of image data from the memory element and to the computer is accomplished.

7. The system as defined in claim 6, wherein the memory element is configured as a FIFO memory or ring buffer.

8. The system as defined in claim 6, wherein control parameters are transferred via the computer to the coder on the basis of user inputs.

9. The system as defined in claim 8, wherein the coder switches between different codings as a function of the control parameters.

10. The system as defined in claim 6, wherein a software program is provided on the computer and transmits to the coder, as a function of user inputs, control parameters for selection of the coding method.

11. The system as defined in claim 10, wherein the coder is equipped with a set of different coding methods of different quality and different scale resolution.

12. The system as defined in claim 6, wherein the image acquisition element possesses an electronic control system; and the coder, which is implemented as an electronic component, is provided between the computer and the electronic control system of the image acquisition element.
